(19) United States
(12) Patent Application Publication
(10) Pub. No.: US 2026/0280738 A1
(43) Pub. Date: Sep. 17, 2026

(54) REAL-TIME SIGNAL STRENGTH MAPPING FOR SPECTRUM REUSE IN A RAN MULTICAST

(71) Applicant: JOHN MEZZALINGUA ASSOCIATES, LLC., Syracuse, NY (US)

(72) Inventor: Matthew OLSON, Edwards, CO (US)

(21) Appl. No.: 19/563,858

(22) Filed: Mar. 11, 2026

Related U.S. Application Data
(60) Provisional application No. 63/771,134, filed on Mar. 13, 2025.

(51) Int. Cl. H04B 17/309; H04B 17/318; H04W 16/14; H04W 74/00

(52) U.S. Cl. CPC H04B 17/347; H04B 17/318; H04W 16/14; H04W 74/004

(57) ABSTRACT

A method for increasing a number of UEs serviced by a cell comprises having a plurality of RUs provide either the PRACH or PUCCH data for every connected UE to a DU. The DU extracts signal strength information for each UE, from each RU, to determine which RU the UE is under. With this done, the DU calculates path loss deltas between each UE to every RU servicing the cell. By applying a threshold to the computed path loss deltas, the DU determines which UEs may be subject to spectrum reuse.

### CROSS-REFERENCE TO RELATED APPLICATION

This application claims the benefit of U.S. Provisional Application No. 63/771,134, filed March 13, 2025, which is hereby incorporated by reference in its entirety.

### BACKGROUND OF THE INVENTION

Conventional 5G NR (New Radio) RAN (Radio Access Network) systems may involve a Central Unit (CU), a Distributed Unit (DU) that is coupled to the CU, and a plurality of Remote Units (RUs) that are coupled to the DU. The multiple RUs may all share a single cell whereby each of the RUs use the same carrier frequencies and some of the RUs may cover overlapping areas.

Under conventional implementations, there is a limit to how many RUs may share a cell. This is because RUs sharing a cell must have their uplink (UL) signals summed, which includes summing the noise from the RUs. A conventional limit is five RUs, beyond which the summed noise worsens the Signal to Noise (SNR) of the summed UL signal.

The result of this is that large complex deployments, such as a stadium, airport, or campus, must have a large number of cells, increasing the cost of a cellular installation.

Accordingly, what is needed is a RAN architecture in which the DUs can support multiple zones of RUs, whereby a given cell may encompass a plurality of zones.

### SUMMARY OF THE INVENTION

An aspect of the present disclosure involves a method for increasing a number of UEs (User Equipment) serviced by a cell. The method involves, among other things, generating, by each of a plurality of RUs (Remote Units), an uplink signal information set, where the uplink signal information set generated by any given one of the plurality of RUs has uplink signal information for each of a plurality of UEs, or a subset thereof, connected to the given one of the RUs. The method also involves transmitting, by each of the plurality of RUs, its uplink signal information set to a BBU (Baseband Unit) and receiving, by the BBU, the uplink signal information set from each of the plurality of RUs. The BBU then obtains a plurality of UE signal strength values from the uplink signal information set received from each of the plurality of RUs, where each of the plurality of signal strength values corresponds to a connection between one of the plurality of UEs and a corresponding RU. The method further involves mapping each of the plurality of signal strength values to a corresonding UE and RU, and indicating which of the plurality of RUs each of the plurality UEs has a strongest connection based on the plurality of UE signal strength values, calculating a plurality of path loss delta between each of the plurality of UEs and each of the plurality of RUs based on the mapping, and applying a path loss delta threshold to the plurality of path loss deltas. Two UEs, of the plurality of UEs, connected to two different RUs, of the plurality of RUs, are identified, where each of the two UEs has a path loss greater than the path loss delta threshold with respect to the RU connected with the other one of the two UEs.

Another aspect of the disclosure involves a method for increasing a number of UEs (User Equipment) serviced by a cell. The method involves receiving, from each of a plurality of RUs (Remote Units), an uplink signal information set, wherein the uplink signal information set of any given one of the plurality of RUs has uplink signal information for each of a plurality of UEs, or a subset thereof, connected to the given one of the RUs; obtaining a plurality of signal strength values from the uplink signal information set of each of the plurality of RUs, wherein each of the plurality of signal strength values corresponding to a connection between one of the plurality of UEs and a corresponding RU; and mapping each of the plurality of signal strength values to a corresonding UE and RU, and indicating which of the plurality of RUs each of the plurality UEs has a strongest connection based on the plurality of UE signal strength values. The method then involves calculating a plurality of path loss deltas between each of the plurality of UEs and each of the plurality of RUs based on the mapping; generating an integrated path loss delta table based on the plurality of path loss deltas and a previous integrated path loss delta table; and applying a path loss delta threshold to the integrated path loss delta table. Still further, the method involves identifying, for each RU, one or more other RU pairs for which the path loss deltas from the integrated path loss delta table are above the path loss delta table threshold.

### BRIEF DESCRIPTION OF DRAWINGS

FIG. 1 illustrates an exemplary RAN edge deployment having a Distributed Unit (DU) that is coupled to a plurality of zones, each of which has a plurality Remote Units (RUs) that share a single cell.

FIG. 2 illustrates the DU and Zone D of FIG. 1, with multiple UEs connected to the RUs of Zone D.

FIG. 3 illustrates an exemplary process for real-time signal strength mapping, selective uplink summing, and spectrum reuse, according to the disclosure.

FIG. 4 illustrates an exemplary signal strength table generated in the process of FIG. 3.

FIG. 5 illustrates an exemplary process for generating an integrated path loss delta table and using that information for identifying spectrum reuse opportunities.

FIG. 6 illustrates an exemplary integrated path loss delta table corresponding to Zone D.

FIG. 7 illustrates Zone D, with integrated path loss deltas determined through multiple iterations of the process of FIG. 5.

FIG. 8 illustrates the exemplary integrated path loss delta table after a threshold has been applied.

### DETAILED DESCRIPTION OF THE INVENTION

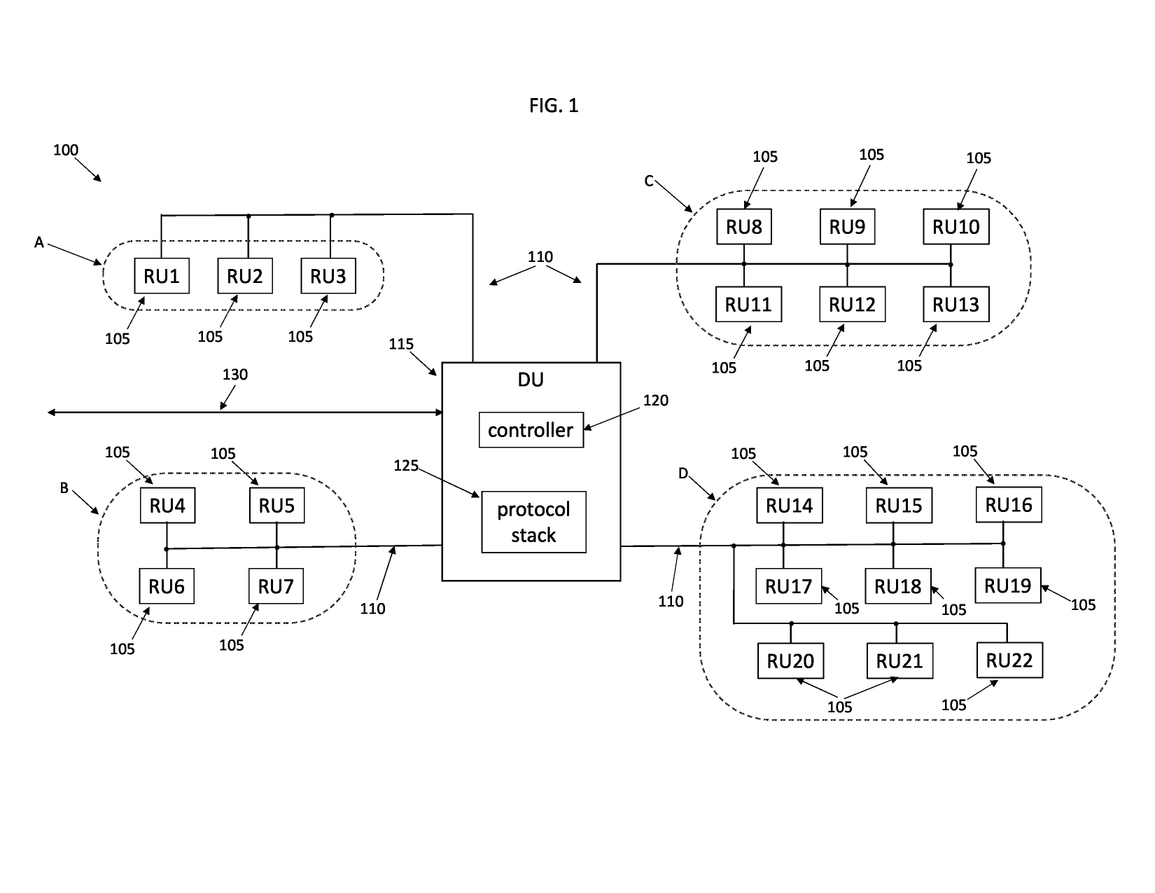

FIG. 1 illustrates an exemplary RAN edge deployment 100 having an exemplary DU 115 that is coupled to a plurality of RUs 105, whereby the RUs 105 are clustered in Zones A, B, C, and D. In the illustrated example, Zone A has RU1, RU2, and RU3; Zone B has RU4, RU5, RU6, and RU7; Zone C has RU8, RU9, RU10, RU11, RU12, and RU13; and Zone D has RU 14, RU15, RU16, RU17, RU18, RU19, RU20, RU21, and RU22.

Exemplary DU 115 may be a 5G implementation of a DU (Distributed Unit) or may be implemented according to the O-RAN (Open-RAN) standard. MAC (Medium Access Control) and upper PHY (Physical) Layer DU 115 may be an example of a Baseband Unit (BBU). Exemplary DU 115 may have a protocol stack module 125 and a controller module 120. Protocol stack module 125 may implement the RLC (Radio Link Control), MAC functionality according to the 5G and O-RAN standards.

Controller module 120 may execute exemplary processes according to the disclosure, as described below.

DU 115 may communicate with a CU (not shown) over an F1 interface 130.

Each of the RUs 105 in deployment 100 may be coupled to DU 115 by an Ethernet network 110 that carries split PHY-layer connection data. If a 7.2x DU/RU split is implemented, then each RU 105 performs low PHY Layer functionality and 7.2x packet data is communicated between each RU 105 and DU 115 over Ethernet network 110. However, deployment 100 may employ an Option 6 DU/RU split, in which case each RU performs all the PHY layer functionality, and the data carried over Ethernet network 110 is between the PHY layer performed by each RU 105 and the MAC layer functionality performed by DU 115.

Each zone may cover a different physical area within a given deployment. For example, in the case of a stadium, Zone A may cover a parking lot and RU1-3 may be high power units; Zone B may cover the concourse; and Zones C and D may cover areas within the stadium bowl and have lower power units and are closely spaced.

All of the disclosed component modules (for example, controller module 120, protocol stack module 125, and any software functionality performed within each RU 105) – and the use of the term “module” herein – may refer to a set of machine-readable instructions that are encoded within one or more non-transitory memory devices and executed on one or more processors within deployment 100. As used herein, the term “non-transitory memory” may refer to any tangible storage medium (as opposed to an electromagnetic or optical signal) and refer to the medium itself, and not to a limitation on data storage (e.g., RAM vs. ROM). For example, non-transitory medium may refer to an embedded memory that is encoded with instructions whereby the memory may have to be re-loaded with the appropriate machine-readable instructions after being power cycled. Each of the modules disclosed herein may be hosted on one or more processors within DU 115 and each of the RUs 105. It will be understood that variations to the how these modules are deployed on a hardware compute environment are possible and within the scope of the disclosure.

Further, if an action is described herein as being done by a referenced module (e.g., “e.g., controller 120 generates a path loss delta table …”), it will be understood that this may describe one or more processors executing the module’s machine-readable instructions to perform the particular action.

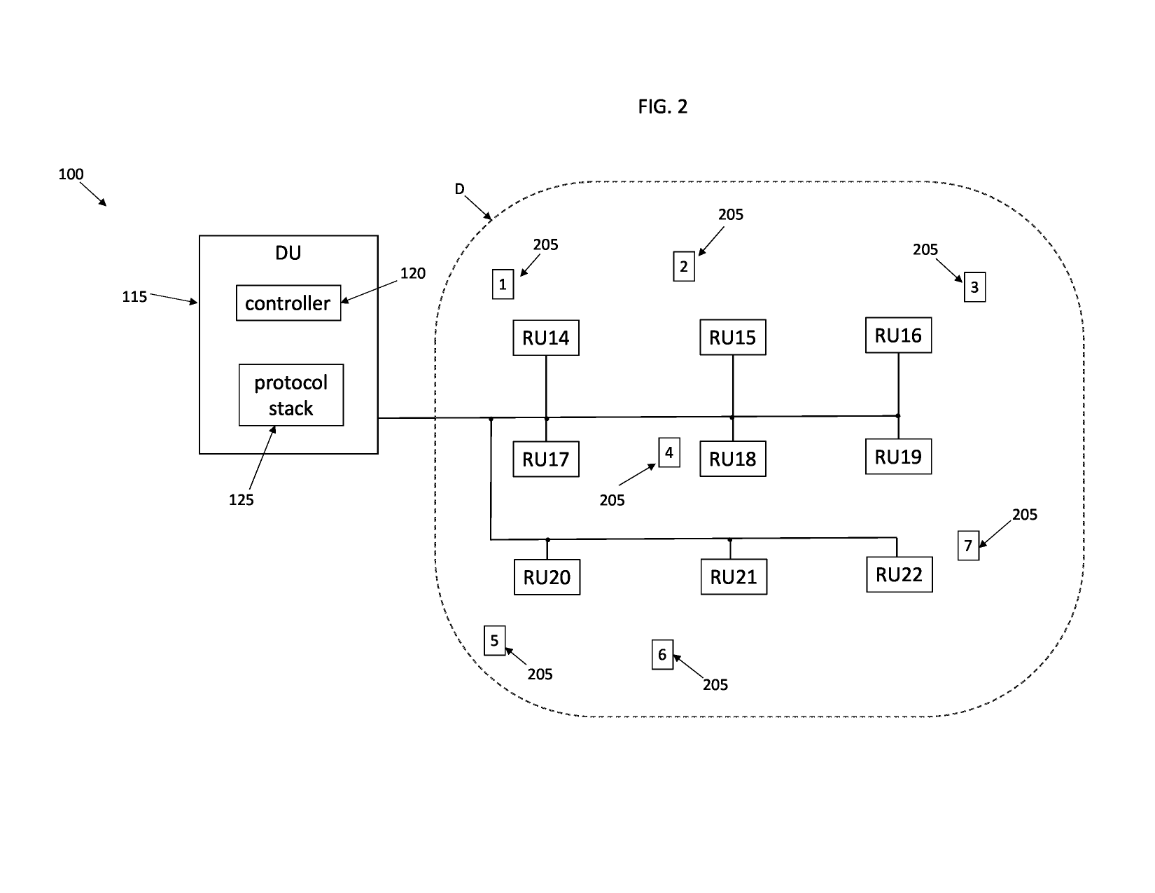

FIG. 2 illustrates exemplary Zone D, coupled to DU 115 over Ethernet network 110. Zones A-C are removed for the purposes of illustration. Connected to the Zone D are seven UEs 205. Each of the UEs 205 may be connected to a subset of the RUs 105 within Zone D.

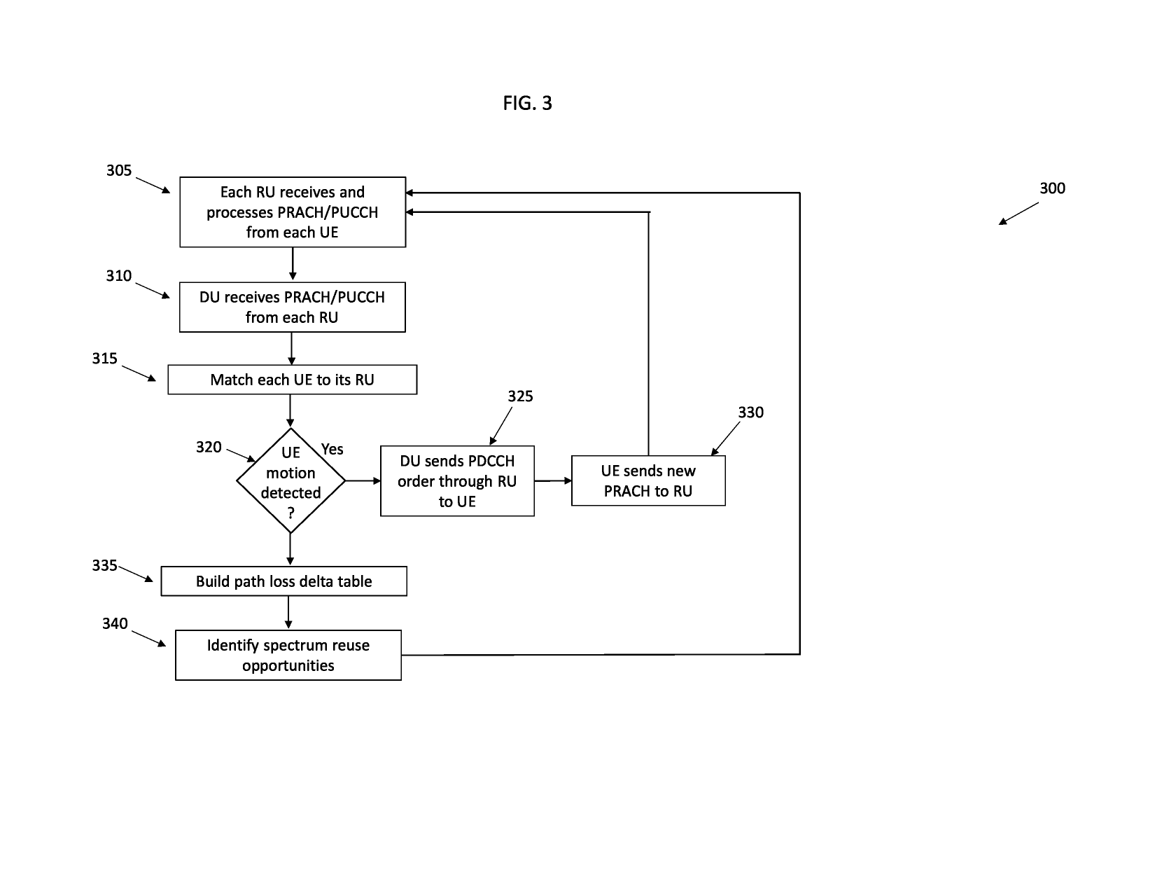

FIG. 3 illustrates an exemplary process 300 for real-time signal strength mapping and spectrum reuse according to the disclosure. Process 300 is described below in the exemplary context of Zone D illustrated in FIG. 2. Process 300 may be performed by deployment 100 that uses a 7.2x DU/RU split.

In step 305, each RU 105 (RU14-22) receives and processes either a PRACH (Physical Random Access Channel) or a PUCCH (Physical Uplink Control Channel) data from each UE 205 connected to it. In this case, each RU14-22 processes the PRACH/PUCCH from each of UE1-7. Each RU14-22 passes this data on to controller 120 in DU 115 over Ethernet network 110.

In step 310, controller 120 within DU 115 receives the PRACH/PUCCH data for each UE1-7 connected to each RU14-22.

In step 315, controller 120 obtains signal strength information from the PRACH/PUCCH data received from each UE1-7 coupled to each RU14-22 and stores this information. In doing so, controller 120 may extract EPRE (Energy per Resource Element) data from the PRACH/PUCCH data for each UE1-7, from each RU14-22. Alternatively, may extract and use other signal quality metrics, such as SNR (Signal to Noise). Controller 120 may store this information in the form of a table.

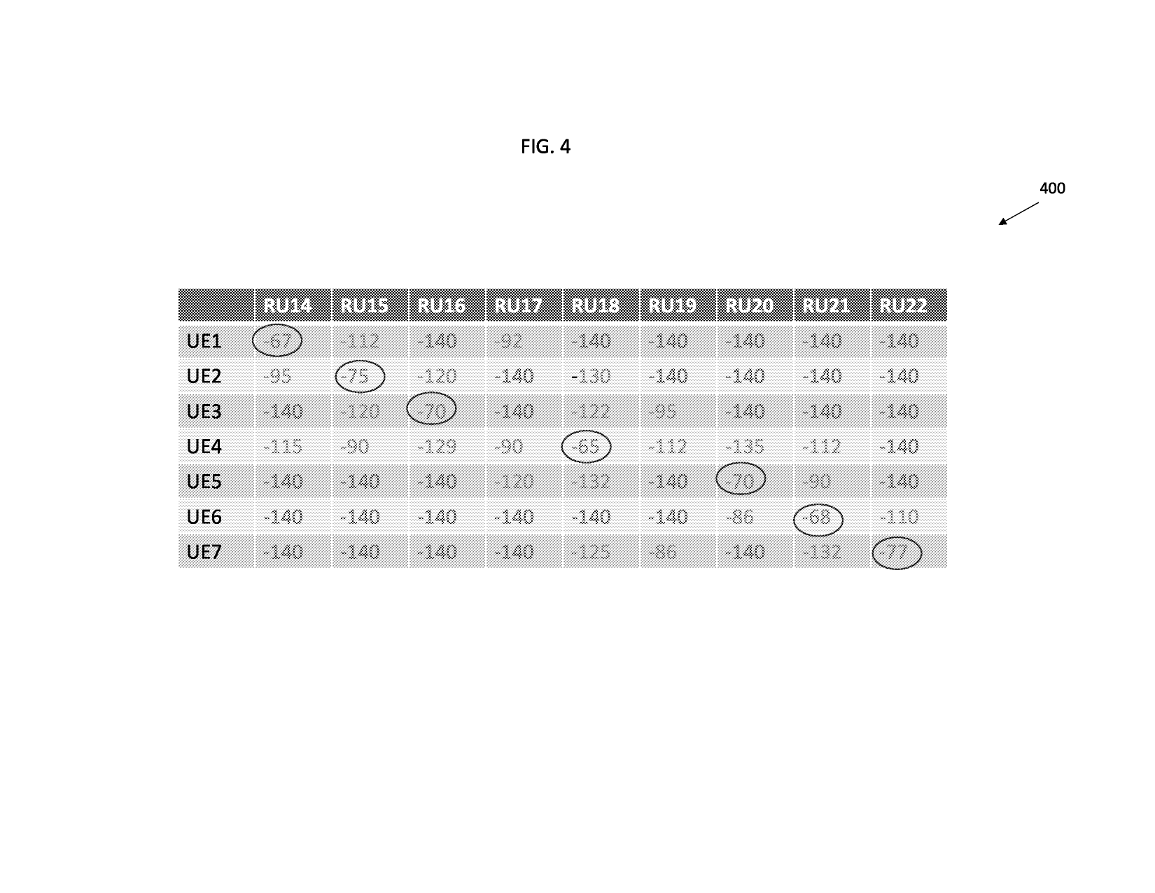

FIG. 4 illustrates an exemplary signal strength table 400 from the data on each UE1-7 from each RU14-22. The data in table 400 represents the SNR (in dB) extracted from the PRACH/PUCCH data received by each RU12-22 from each UE1-7.

Further to step 315, controller 120 identifies, for each UE1-7, the RU14-22 that the UE is under. From table 400, based on best SNR, UE1 is under RU14; UE2 is under RU15; UE3 is under RU16; UE4 is under RU18; UE5 is under RU20; UE6 is under RU21; and UE7 is under RU22. In addition to identifying the RU14-22 that has a best connection to each UE1-7, table 400 also reveals location information. Since the location of each RU14-22 is known within Zone D, the location of each UE1-7 may be inferred. It is also used to identify opportunities for spectrum reuse and selective uplink summing, as is described below.

Controller 120 stores table 400 along with previous tables 400 generated in earlier iterations of process 300. Process 300 may be executed every 200 msec.

In step 320, controller 120 identifies if any UE1-7 has moved from one RU14-22 to another. It may do so by comparing table 400 with one or more previous tables 400 from previous iterations of process 300. Controller 120 may identify motion by comparing the current table 400 with the one or more previous tables 400 to find cases where the RU14-22 that a given UE1-7 is under has changed. If so, and for those UEs for which motion has been detected, process 300 proceeds to step 325.

In step 325, for any UE1-7 that controller 120 determines to have moved, controller 120 instructs DU 115 to send a PDCCH (Physical Download Control Channel) order to the UE, triggering a RACH (Random Access Channel) procedure between the UE1-7 and DU 115. This acts like an intra-cell handover between RUs.

In response, in step 330, the UE1-7 given the PDCCH order sends a PRACH request to the RU14-22 to which it is connected, as identified in step 315 and indicated in table 400. The given RU14-22 will process the newly-issued PRACH request in the next iteration of process 300.

In step 335, controller calculates an array of path loss deltas for all of the entries in table 400, including any UE1-7 determined to have moved in step 320. A path loss delta may be, for a given UE1-7, the difference in signal strength between the RU14-22 that the UE1-7 is under and the signal strengths experienced with each other RU14-22 (e.g., across a given row of table 400).

For example, UE1 is under RU14. The path loss deltas to the other RUs are as follows: RU15-RU14 = -45dB; RU16-RU14 = -73dB; RU17-RU14 = -25dB; RU18-RU14 = -73dB; RU19-RU14 = -73dB; RU20-RU14 = -73dB; RU21-RU14 = -73dB; and RU22-RU14 = -73dB.

Further, UE5 is under RU20. The path loss deltas to the other RUs are as follows: RU14-RU20 = -70dB; RU15-RU20 = -70dB; RU16-RU20 = -70dB; RU17-RU20 = -50dB; RU18-RU20 = -62dB; RU19-RU20 = -70dB; RU21-RU20 = -20dB; and RU22-RU20 = -70dB.

Accordingly, controller 120 calculates path loss deltas for each UE1-7.

In step 340, controller 120 identifies opportunities for spectrum reuse. It may do so by identifying two (or more) UEs of UEs 1-7, where each of the two UEs are connected to a different one of the RUs of RU14-RU22 with a path loss delta that does not exceed the configurable threshold, but where each of the two UEs has a path loss delta greater than the configurable threshold with respect to the RU of the other one of the two UEs. Because of this, the two UEs may communicate with the their different RUs, respectively, using the same spectrum resource(s).

For example, controller 120 identifies that the path loss delta for UE1 to RU20 is -73dB; and that the path loss delta for UE5 to RU14 is -70dB. If the configurable path loss delta threshold is, for example, -60dB, then UE1 and UE5 are candidates for spectrum reuse. In this case, controller 120 may notify the MAC scheduler within protocol stack implementation 125 within DU 115 may allocate the same resource blocks to UE1 (under RU14) and UE5 (under RU20).

According to table 400, UE1 may be suitable for spectrum reuse with UE6 or UE7, using the same calculations done between UE1 and UE5 above. However, UE1 is suitable for spectrum reuse with only one of UE5 and UE6. This is because EU5 is unsuitable for spectrum reuse with UE6, because UE5’s path loss delta to RU21 is -20dB, and UE6’s path loss delta to RU20 is -18dB. However, it may be noted that the path loss deltas between UE5 and RU22 and between UE7 and RU20 are such that spectrum reuse may be performed between UE5 and UE7. And given that the path loss deltas between UE1 and UE5 and UE7 are greater than the configurable threshold, UE1, UE5 and UE7 may all be allocated the same time and spectrum resources by MAC scheduler (not shown) within protocol stack 125.

In a counter-example, the path loss delta for UE1 to RU15 is -45dB, and the path loss delta for UE2 to RU14 is -20dB. Both of these path loss deltas are less than the path loss delta threshold. Accordingly, controller 120 identifies UE1 and UE2 as unsuitable for spectrum reuse.

Further to step 340, controller 120 provides instructions to the MAC scheduler within protocol stack 125 regarding which UEs may share the same spectrum resources.

With step 305 complete, process 300 repeats, with table 400 stored for use in the next iteration.

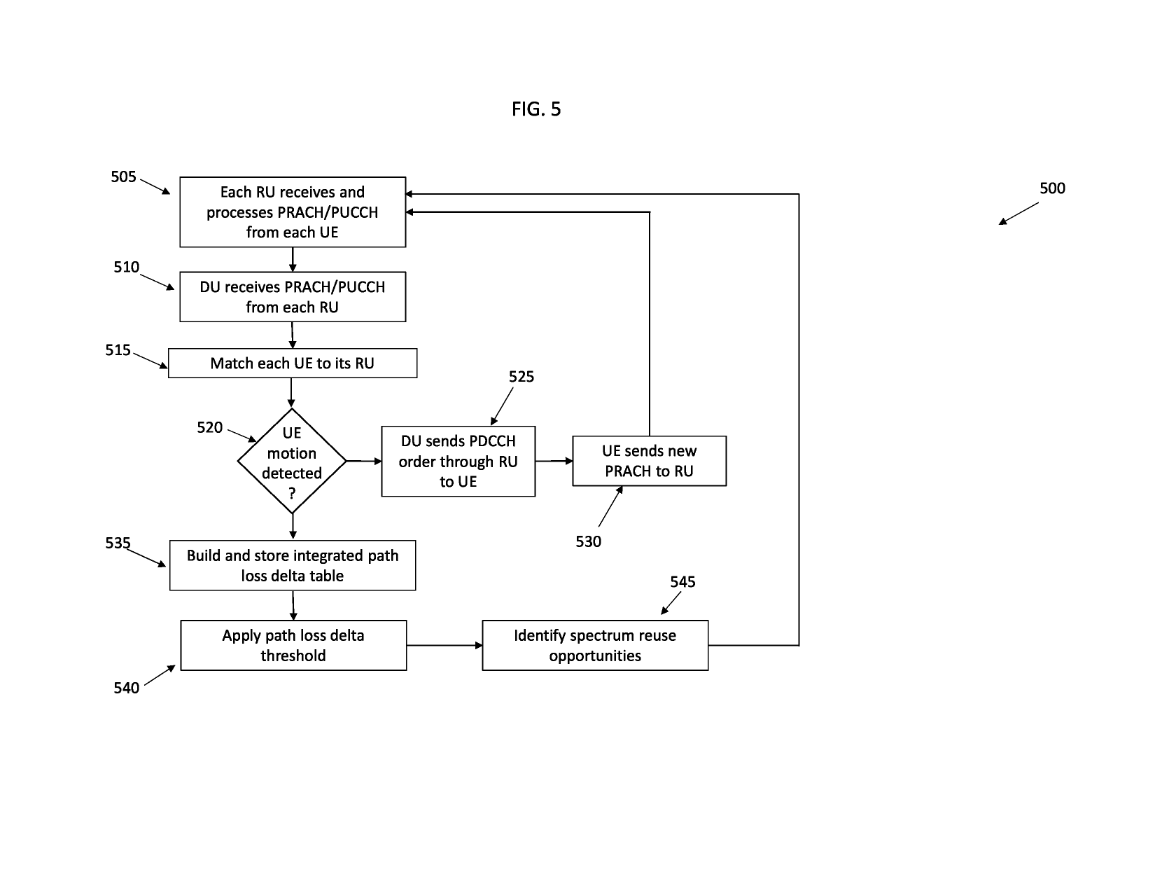

FIG. 5 illustrates an exemplary process 500 for generating an integrated path loss delta table and using that information for identifying spectrum reuse opportunities. Process 500 is implemented in a version of deployment 100 that uses an Option 6 DU/RU split, in which each RU14-22 performs all the PHY layer functionality, and the data carried over Ethernet network 110 is between the PHY layer performed by each RU 105 and the MAC layer functionality performed by DU 115.

Steps 505-515 and 520-530 may be substantially similar to the corresponding steps of process 300. The key difference is that controller 120 receives fully processed PHY layer data from each RU14-22 for each UE1-7, and protocol stack module 125 in DU 115 has no PHY layer functionality.

In step 535, controller 120 builds an integrated path loss delta table. However, in step 535, the process is integrative over multiple iterations of process 500. Controller 120 builds a history of UE connections to the different RUs14-22 and identifies patterns of path loss deltas that are not UE-specific but trended over multiple UEs over time. In other words, if a UE is under RUX, the integrated path loss delta table provides statistically generated path loss deltas to the other RUs14-22.

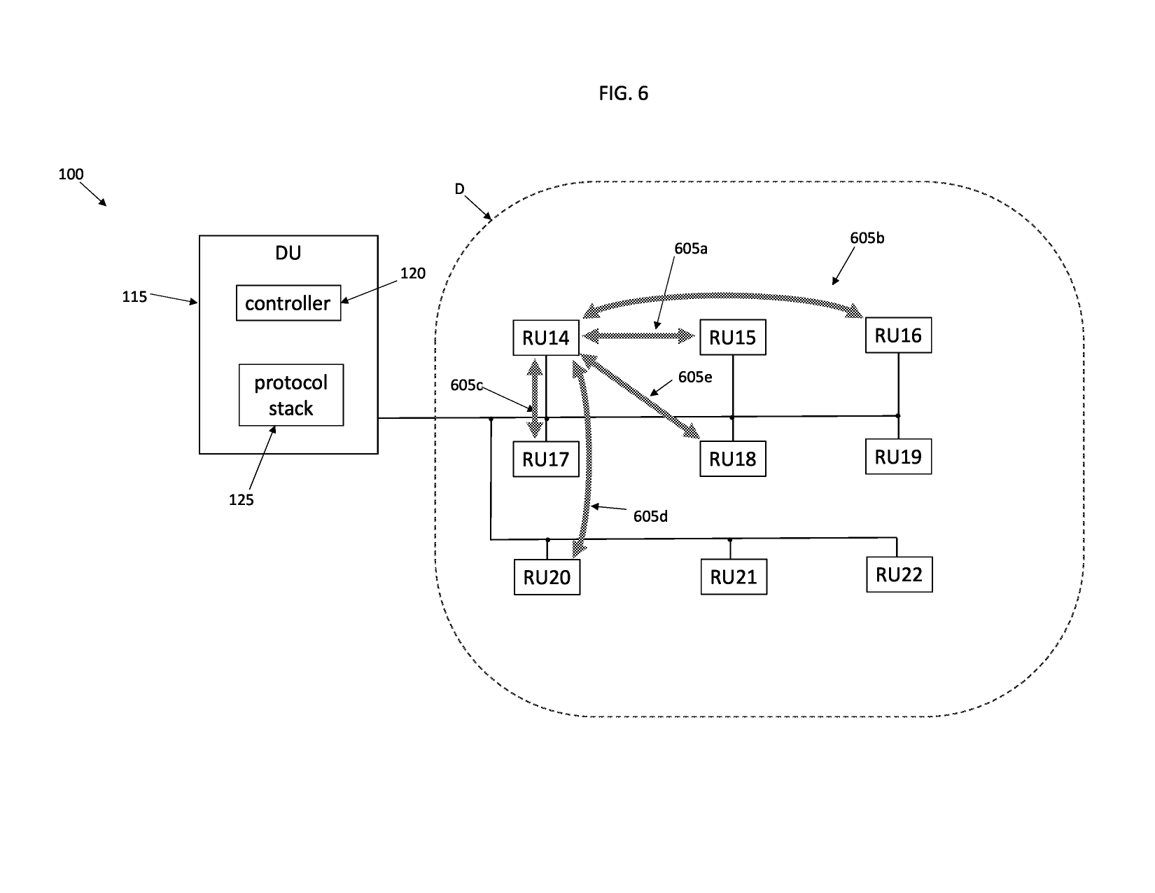

FIG. 6 illustrates an exemplary set of integrated path loss deltas in Zone D. Path loss delta 605a represents the accumulated path loss deltas between RU14 and RU15. Path loss delta 605a represents the accumulated path loss deltas over multiple iterations of process 500, involving many different UEs under either RU14 or RU15. Similarly, path loss delta 605b represents the accumulated path loss delta between RU14 and RU16. Path loss delta 605c represents the accumulated path loss delta between RU14 and RU1. Path loss delta 605d represents the accumulated path loss delta between RU14 and RU120. Path loss delta 605e represents the accumulated path loss delta between RU14 and RU18. All of the integrated path loss deltas illustrated in FIG. 6 pertain to RU14. Not shown are the similar path loss deltas relative to other RUs, such as RU22. It will be understood how the integrated path loss deltas would map for any of the RUs14-22, such as RU22.

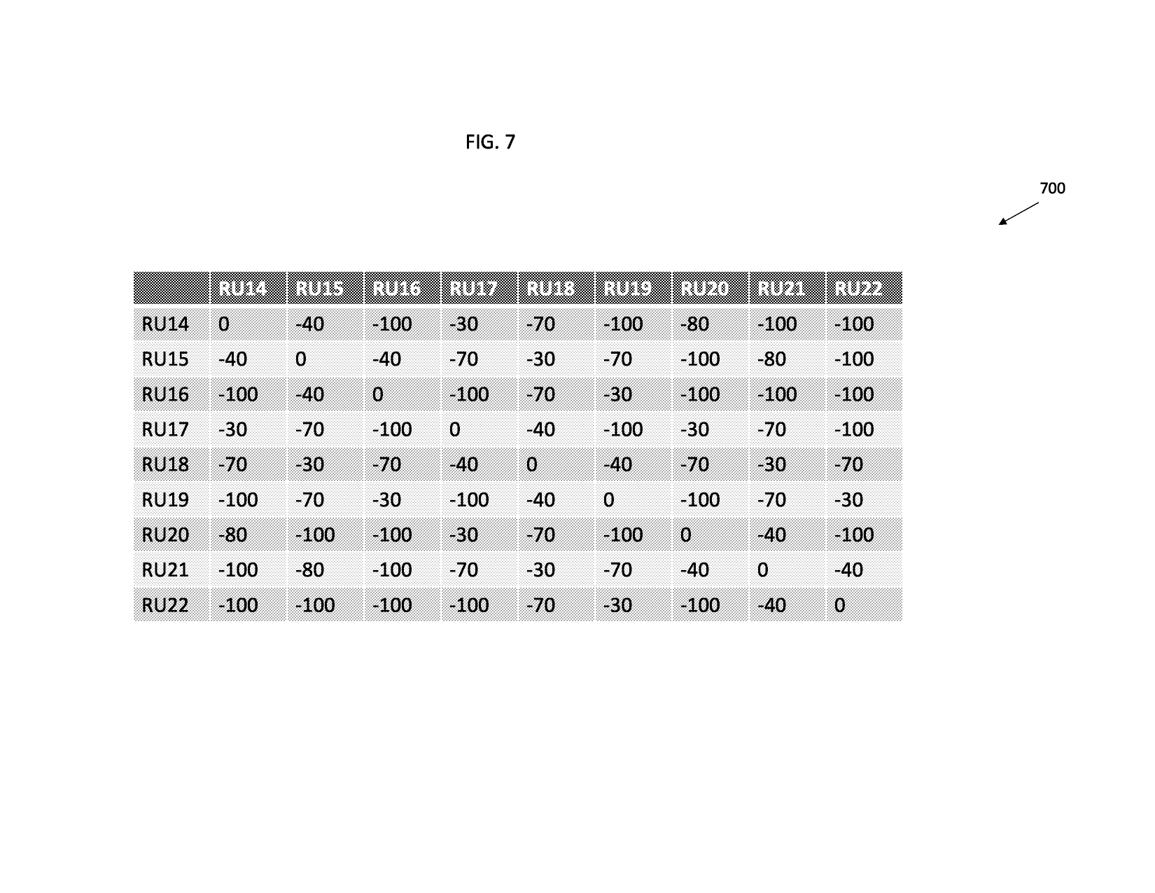

FIG. 7 illustrates an exemplary integrated path loss delta table 700. Integrated path loss delta table 700 provides the statistically generated integrated path loss deltas between each RU14-22, based on multiple iterations of process 500 with numerous UEs.

In step 540, controller 120 applies a configurable path loss delta threshold to the integrated path loss delta table generated in step 535. In this example, the configurable path loss delta threshold is set at -50dB. In doing so, controller 120 identifies, for a given RU14-22, which other RUs14-22 have a sufficiently large path loss delta (e.g., exceeding the configurable threshold) so that the resource blocks assigned to a UE under that RU14-22 may be reused by UEs under other so-designated RUs.

The path loss delta threshold is configurable because conditions within deployment 100 may change. For example, if a higher order QAM (Quadrature Amplitude Modulation) is used, the threshold may be higher in that a higher path loss delta may be required relative to a lower order QAM.

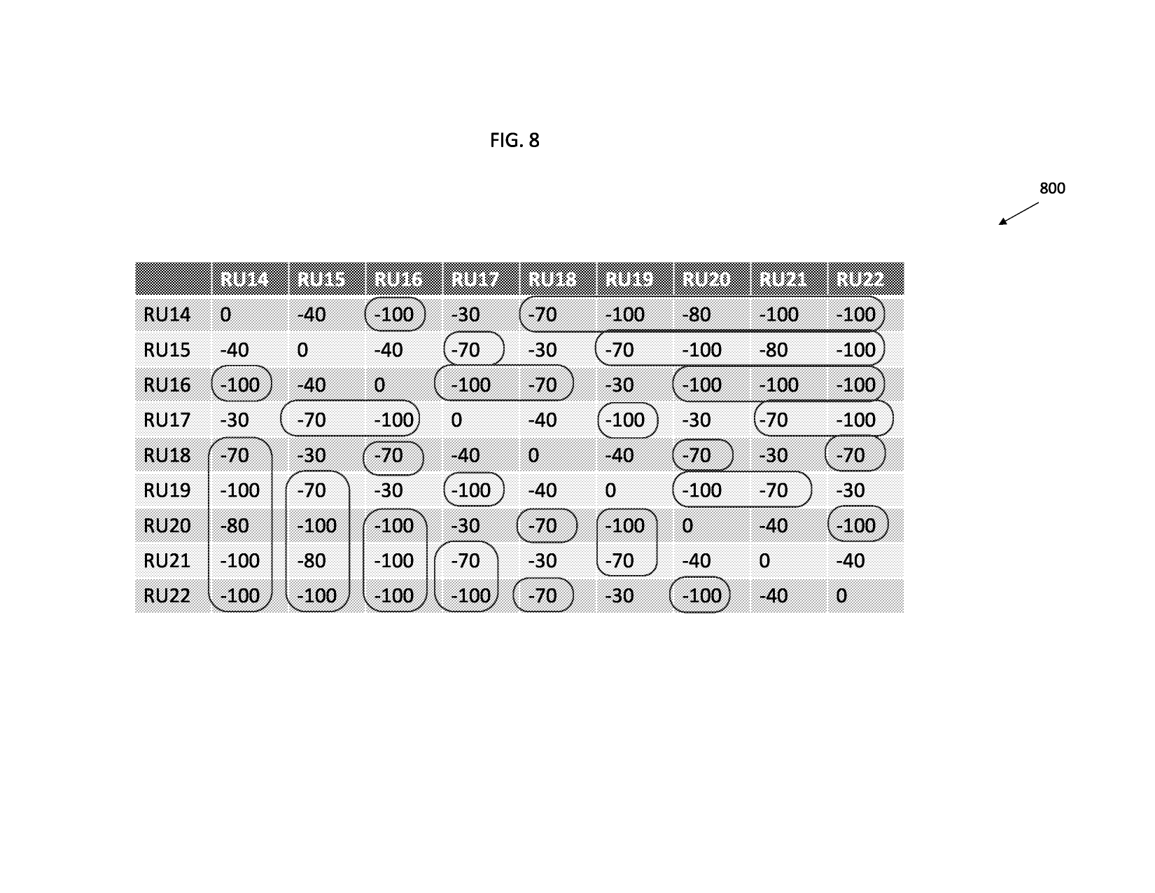

FIG. 8 illustrates an exemplary integrated path loss delta table 800 in which high path loss deltas between RUs14-22 are identified. These are the integrated path loss deltas that are above the configurable threshold applied in step 540. For example, any UE under RU14 may have its resource blocks shared with any UE under RU16, or RUs18-22. Any UE under RU15 may have its resource blocks shared with any UE under RU17, or RU19-22. Any UE under RU19 may have its resource blocks shared with any UE under RU20-21, RU17, or RU14-15.

In step 545, controller 120 identifies opportunities for spectrum reuse between UEs under different RUs14-22, using integrated path loss delta table 800. In doing so, controller 120 may allocate a single set of resource blocks to only two UEs under a pair of RUs14-22 identified in table 800. However, it may be possible for spectrum reuse with three UEs, provided that each is under a different RU14-22 and each RU14-22 is identified as a candidate for spectrum reuse for both other RUs14-22.

Further to step 340, controller 120 provides instructions to the MAC scheduler within protocol stack 125 regarding which UEs may share the same spectrum resources.

There are advantages to process 500 using a deployment 100 in which Option 6 split is used over Ethernet network 110. Under the Option 6 split, each RU 105 has its own embedded PHY layer implementation, and protocol stack 125 in DU 115 has the MAC scheduler as its lowest processing layer. Given that no PHY layer processing is done within DU 115, this allows for greater flexibility and scalability in the number of RUs 105 that DU 115 ca support. Accordingly, with the Option 6 split, all of Zones A-D may operate under the same cell simultaneously, given that the path loss deltas between zones make spectrum reuse possible.

Process 500 may be modified so that spectrum reuse opportunities between currently processed UEs1-7 may also be identified in real time with the current path loss delta table. In this case, process 700 may be enhanced so that controller 120 executes steps 335-340 of process 300 as well as performing steps 535-545 of process 500. It will be understood that such variations are possible and within the scope of the disclosure.

It will be understood that the signal strength (SNR) numbers in table 400/700/800 are exemplary and for the purposes of illustration. Actual SNR numbers may be in different ranges and may be closer in value. The same is true for the example configurable thresholds.

Although the above exemplary embodiment involves a 5G gNodeB, it will be understood that edge RAN deployment 100 may involve an LTE eNodeB, and that such variations are within the scope of the disclosure.

What is claimed is:

1. A method for increasing a number of UEs (User Equipment) serviced by a cell, comprising:
generating, by each of a plurality of RUs (Remote Units), an uplink signal information set, wherein the uplink signal information set generated by any given one of the plurality of RUs has uplink signal information for each of a plurality of UEs, or a subset thereof, connected to the given one of the RUs;
transmitting, by each of the plurality of RUs, its uplink signal information set to a BBU (Baseband Unit);
receiving, by the BBU, the uplink signal information set from each of the plurality of RUs;
obtaining, by the BBU, a plurality of UE signal strength values from the uplink signal information set received from each of the plurality of RUs, wherein each of the plurality of signal strength values corresponds to a connection between one of the plurality of UEs and a corresponding RU;
mapping each of the plurality of signal strength values to a corresonding UE and RU, and indicating which of the plurality of RUs each of the plurality UEs has a strongest connection based on the plurality of UE signal strength values;
calculating a plurality of path loss delta between each of the plurality of UEs and each of the plurality of RUs based on the mapping;
applying a path loss delta threshold to the plurality of path loss deltas; and
identifying two UEs, of the plurality of UEs, connected to two different RUs, of the plurality of RUs, wherein each of the two UEs has a path loss greater than the path loss delta threshold with respect to the RU connected with the other one of the two UEs.

2. The method of claim 1 further comprising:
identifying spectrum reuse opportunities based on the identifying of the two UEs of the plurality of UES.

3. The method of claim 1, wherein the uplink signal information comprises a PRACH (Physical Random Access Channel).

4. The method of claim 1, wherein the uplink signal information comprises a PUCCH (Physical Uplink Control Channel).

5. The method of claim 1, wherein each of the plurality of signal strength values comprises an SNR (Signal to Noise Ratio).

6. The method of claim 1, wherein each of the plurality of signal strength values comprises an EPRE (Energy per Resource Element).

7. The method of claim 1, wherein each of the plurality of signal strength values comprises an RSRP (Reference Signal Received Power).

8. The method of claim 1, further comprising:
detecting a motion of a given UE, based on the mapping.

9. The method of claim 8, wherein detecting a motion of a given UE comprises:
retrieving a previous mapping;
detecting, between the mapping and the previous mapping, for the given UE, a change in RU to which the given UE has the strongest connection.

10. The method of claim 1, further comprising:
identifying the two UEs, of the plurality of UEs, to a MAC (Medium Access Control) scheduler.

11. A method for increasing a number of UEs (User Equipment) serviced by a cell, comprising:
receiving, from each of a plurality of RUs (Remote Units), an uplink signal information set, wherein the uplink signal information set of any given one of the plurality of RUs has uplink signal information for each of a plurality of UEs, or a subset thereof, connected to the given one of the RUs;
obtaining a plurality of signal strength values from the uplink signal information set of each of the plurality of RUs, wherein each of the plurality of signal strength values corresponding to a connection between one of the plurality of UEs and a corresponding RU;
mapping each of the plurality of signal strength values to a corresonding UE and RU, and indicating which of the plurality of RUs each of the plurality UEs has a strongest connection based on the plurality of UE signal strength values;
calculating a plurality of path loss deltas between each of the plurality of UEs and each of the plurality of RUs based on the mapping;
generating an integrated path loss delta table based on the plurality of path loss deltas and a previous integrated path loss delta table;
applying a path loss delta threshold to the integrated path loss delta table; and
identifying, for each RU, one or more other RU pairs for which the path loss deltas from the integrated path loss delta table are above the path loss delta table threshold.

12. The method of claim 11 further comprising:
identifying a spectrum reuse opportunity based on the identification of the one or more other RU pairs.

13. The method of claim 11, further comprising identifying the one or more RU pairs to a MAC (Medium Access Control) scheduler.

14. The method of claim 11, wherein the uplink signal information comprises a PRACH (Physical Random Access Channel).

15. The method of claim 11, wherein the uplink signal information comprises a PUCCH (Physical Uplink Control Channel).

16. The method of claim 11, wherein each of the plurality of signal strength values comprises an SNR (Signal to Noise Ratio).

17. The method of claim 11, wherein each of the plurality of signal strength values comprises an EPRE (Energy per Resource Element).

18. The method of claim 11, wherein each of the plurality of signal strength values comprises an RSRP (Reference Signal Received Power).

19. The method of claim 11, further comprising:
detecting a motion of a given UE, based on the mapping.

20. The method of claim 19, wherein detecting motion of a given UE comprises:
retrieving a previous mapping;
detecting, between the mapping and the previous mapping, for the given UE, a change in RU to which the given UE has the strongest connection.
